(19) United States
(12) Patent Application Publication
(10) Pub. No.: US 2007/0048192 A1
(43) Pub. Date: Mar. 1, 2007

(54) Integrated microfluidic vias, overpasses, underpasses, septums, microfuses, nested bioarrays and methods for fabricating the same

(76) Inventors: Emil Kartalov, Pasadena, CA (US); Axel Scherer, Laguna Beach, CA (US); W.French Anderson, (US)

Correspondence Address: Daniel L. Dawes;MYERS DAWES ANDRAS & SHERMAN LLP, Suite 1150, 19900 MacArthur Boulevard, Irvine, CA, 92612, US

(21) Appl. No.: 11/502,135

(22) Filed: Aug. 9, 2006

Related U.S. Application Data
(60) Provisional application No. 60/707,007, filed on Aug. 10, 2005.
(60) Provisional application No. 60/726,058, filed on Oct. 12, 2005.
(60) Provisional application No. 60/764,245, filed on Feb. 1, 2006.

(51) Int. Cl. B01L 3/02

(52) U.S. Cl. 422/100

(57) ABSTRACT

A method comprises the steps of providing a first mold with a high and low features. A first layer is formed over the features. The high feature extends a predetermined height through the first layer to define a via or extends near to the first layer to define a membrane of predetermined thickness. The low feature defines a lower channel in the first layer which is communicated with the via or membrane. The second layer has an upper channel formed therein, so that the high feature extends into the upper channel in the second layer or is positioned adjacent to the upper channel in the second layer. The first mold is removed. The partially completed structure is assembled onto a substrate to result in a via, septum or microfuse formed between different, adjacent vertical levels in the multilayer microfluidic circuit.

### RELATED APPLICATIONS

The present application is related to U.S. Provisional Patent Applications: Ser. No. 60/707,007, filed on Aug. 10, 2005; Ser. No. 60/726,058, filed on Oct. 12, 2005; and Ser. No. 60/764,245, filed on Feb. 1, 2006, each of which are incorporated herein by reference and to which priority is claimed pursuant to 35 USC 119.

### GOVERNMENT RIGHTS

The invention was developed in part with funds from the National Institutes of Health pursuant to contract 1R01 HG002644-01A1. The U.S. Government has certain rights.

### BACKGROUND OF THE INVENTION

1. Field of the Invention

The invention relates to the field of microfluidic structures and methods of fabrication of the same.

2. Description of the Prior Art

Microfluidics is a technology that is establishing itself as an innovative practical tool in biological and biomedical research. Microfluidics offers the advantages of economy of reagents, small-sample handling, portability, and speed. PDMS (polydimethylsiloxane) microfluidics in particular also offers industrial up-scalability, parallel fabrication, and a unique capability for complex fluid handling schemes through fluidic networks containing integrated valves and pumps.

Up to now, the configuration of such devices fell into two distinct categories, “pushup” and “pushdown” devices as shown in side cross-sectional view in FIGS. 1a and 1b depending on which direction the microvalve membranes deflected to shut off reagent flow. Both types of devices have advantages and disadvantages, which limit their usefulness in specific applications. For example, pushdown devices must be used in applications where the reagents need to access the glass surface of the substrate, e.g. when microfluidic chips are aligned on top of DNA or protein microarrays printed on the glass substrate. References to a “chip” hereinafter shall be understood to refer to a microfluidic chip or a device which is at least partly microfluidic in design. On the other hand, pushup devices allow the practical valving of significantly deeper reagent channels (˜40 μm instead of ˜10 μm), e.g. in applications involving mammalian cells. It is clear then that none of the available configurations is usable in applications demanding both deep channels and access to the glass substrate, e.g. on-chip mammalian cells expression analysis by printed microarrays. Finally, in both currently available configurations, the reagent flow is restricted to two dimensions, which severely limits the attainable device complexity.

Over the decade of its existence, PDMS (polydimethylsiloxane) microfluidics has progressed from the plain microchannel (1) through pneumatic valves and pumps to an impressive set of specialized components organized by the thousands in multilayer large-scale-integration devices. These devices have become the hydraulic elastomeric embodiment of Richard Feynman's dreams of infinitesimal machines. The now established technology has found successful application in protein crystallization, DNA sequencing, nanoliter PCR, cell sorting and cytometry, nucleic acids extraction and purification, immunoassays, cell studies, and chemical synthesis, while also serving as the fluid handling component in emerging integrated MEMS (microelectromechanical system) devices.

The prior art has developed an ingenious scheme wherein a complex system of multilayer photoresist molds, photoresist pre-masters, and PDMS masters were fabricated and then used in an involved many-step process to produce a 70 μm-thick PDMS layer with 100 μm-wide vertical cylinders connecting 70 μm-tall channels fabricated in thick PDMS slabs. The resulting three-dimensional technique was successfully used in protein and cell patterning, but the challenging and labor-intensive fabrication of the devices has largely dissuaded researchers from further work along the same path.

The energetic pursuit of applications however has resulted in a premature attention shift away from fundamental microfluidics. What is needed is a fundamental technological advance that allows a simple and easy access to a large increase in the architectural complexity of microfluidic devices, as well as new possibilities for technical developments and consequent applications.

### BRIEF SUMMARY OF THE INVENTION

The illustrated embodiments of the invention are directed to what is termed in this specification as a “via”, in reference to its analog in modern semiconductor electronics. Vias are vertical micropassages that connect channels fabricated in different layers of the same PDMS multilayer chip. The functional result is three-dimensional channels that break the restrictions of the traditional architecture wherein channels could never leave their layer and two channels within the same layer could never cross without mixing.

The illustrated embodiments of the invention are presented as several new device components for soft-lithography microfluidics. Vias connect channels residing in different layers, thus allowing the integration of pushup and pushdown control configurations within the same monolithically fabricated device. Thus, vias enable new applications that require the features of both traditional configurations. An overpass and underpass is constructed by connecting two vias by a channel in the upper and lower layer, respectively. Overpasses and underpasses allow channels to cross without fluidic connection, thereby significantly increasing the maximal achievable complexity of the device architectures for both layers.

Septums are thin polymer membranes separating channels lying in different layers. When the driving pressure exceeds a critical preprogrammed value, the septums rupture and henceforth allow fluid flow between the two channels. One application of septums is to keep device compartments watertight until the latter need to be accessed. In an analogy with electrical fuses, microfuses are septums used as a safety feature to vent fluids to exhaust ports, thereby protecting the rest of the device from excessive pressure. Systems of microfuses configured to breach at different pressures can be used to direct flow in passive valveless devices. All described devices can be built using conventional soft-lithography fabrication techniques and are fully compatible with other conventional device components.

Vertical passages or vias, connecting channels located in different layers, are fabricated monolithically, in parallel, by simple and easy means. The resulting three-dimensional connectivity greatly expands the potential complexity of microfluidic architecture. We apply the vias to printing nested bioarrays. We also describe microfluidic membranes and their applications. Vias lay the foundation for a new generation of microfluidic devices.

A method of forming a via, septum or microfuse in a multilayer microfluidic circuit comprises the steps of providing a first mold with at least one high feature and at least one low feature. A first layer is formed over the high feature and a low feature on the first mold. The high feature extends a predetermined height through the first layer to later define a via or extends to near the upper surface of the first layer to later define a membrane therein of a predetermined thickness. The low feature defines a later formed lower channel in the first layer in communication with the later formed via or membrane. A second layer is provided on the first layer. The second layer has at least one upper channel formed therein, so that the high feature extends into the upper channel in the second layer or is positioned adjacent to the upper channel in the second layer. The first mold including the high feature and the low feature is removed to define a partially completed structure. The partially completed structure is assembled onto a substrate layer to result in a via, septum or microfuse formed between different, adjacent vertical layers in the multilayer microfluidic circuit.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1a is an enlarged side cross-sectional view of a prior art push-down device. All figures in the specification are diagrammatic and are provided for schematic illustration only and are not necessary drawn to scale.

FIG. 1b is an enlarged side cross-sectional view of a prior art push-up device.

FIG. 2a is an enlarged side cross-sectional view of a mold shown in the first step of the fabrication of a via according to the invention.

FIG. 2b is an enlarged side cross-sectional view of the step of depositing a PDMS layer on the mold of FIG. 2a.

FIG. 2c is an enlarged side cross-sectional view of the step preparing a second thicker PDMS layer on another mold, which layer is later attached to the structure of FIG. 2b.

FIG. 2d is an enlarged side cross-sectional view of the step assembling the PDMS layer from FIG. 2c onto the structure of FIG. 2b after peeling it off its mold shown in FIG. 2c.

FIG. 2e is an enlarged side cross-sectional view of the step removing the mold of FIG. 2a and thus releasing the via.

FIG. 2f is an enlarged side cross-sectional view of the step disposing a glass substrate on the bottom of the resulting structures FIG. 2e.

FIG. 3a is an enlarged side cross-sectional view of an overpass fabricated using two vias fabricated by the method of FIGS. 2a-2e.

FIG. 3b is an enlarged side cross-sectional view of an underpass fabricated using two vias fabricated by the method of FIGS. 2a-2e.

FIG. 4a is an enlarged side cross-sectional view of a mold shown in the first step of the fabrication of a septum or microfuse according to the invention.

FIG. 4b is an enlarged side cross-sectional view of the step of disposing a PDMS layer on the mold of FIG. 4a.

FIG. 4c is an enlarged side cross-sectional view of the step of assembling a formed PDMS layer with a defined channel on the features of FIG. 4b.

FIG. 4d is an enlarged side cross-sectional view of the step removing the mold from the features of FIG. 4c.

FIG. 4e is an enlarged side cross-sectional view of the step of disposing a glass substrate on the bottom of the resulting structures FIG. 4d showing the completed septum or microfuse.

FIG. 4f is an enlarged side cross-sectional view of the structures FIG. 4e after the septum or microfuse has ruptured.

FIG. 5 is a layout diagram of a chip in which rounded via fabrication parameters were optimized. 7×100 μm channels in the lower layer and 36×100 μm channels in the upper layer were connected by vias of 25-80 μm lateral dimensions, to produce four independent sets of three-dimensional channels. Optimal performance was achieved with 50-65 μm wide vias and 4000 rpm PDMS spin speed on 3-inch wafers.

FIG. 6a is a microphotograph of a top plan view of two channels connected with a non-rounded via.

FIG. 6b is a microphotograph of a side cross-sectional view of two channels connected with a non-rounded via. The chip was peeled off the slide, cut with a razor, and laid on its side to take the photo.

FIG. 6c is a microphotograph of a top plan view the 4-plex design of FIG. 5 executed with non-rounded vias at 2500 rpm PDMS spin speed. The four channel sets were then tilled with solutions containing plain buffer, fluorescein, Cy3, and Cy5 dyes; a colorless image and three false-color fluorescence images in blue, green, and red, respectively, were combined to produce the shown result. Of the 288 vias of varying sizes, there were only 2 defective ones (seen here at the ends of what should be a red segment, mid-row, second from the right), suggesting that surface tension can produce septa for sufficiently wide features of a non-rounded mold.

FIG. 7a is a layout diagram of a chip attached to an epoxide-coated slide.

FIG. 7b is an enlarged view of four non-mixing sets of channels of FIG. 7a which access the substrate surface at one location each.

FIG. 7c is a false color fluorescence microphotograph demonstrating the correct assembly of sandwich immunoassays of the nested bioarrays.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

The illustrated embodiments include a method which comprises the steps of providing a first mold with a high and low features. A first layer is formed over the features. The high feature extends a predetermined height through the first layer to define a via or extends near to the first layer to define a membrane of predetermined thickness. The low feature defines a lower channel in the first layer which is communicated with the via or membrane. The second layer has an upper channel formed therein, so that the high feature extends into the upper channel in the second layer or is positioned adjacent to the upper channel in the second layer. The first mold is removed. The partially completed structure is assembled onto a substrate to result in a via, septum or microfuse formed between different, adjacent vertical levels in the multilayer microfluidic circuit, or the structure is assembled with a similarly prepared first layer to comprise multiple levels of vias, septums and/or microfuses.

The illustrated embodiments of the invention include a new device component, a microfluidic via 10, and a methodology for its fabrication. Vias 10 allows the two alternative control schemes to be united within the same device thus gaining the benefits of both. Moreover, systems of vias 10 can be used to construct overpasses 12 and underpasses 14 that allow reagent channels 16 to cross without mixing by use of the third dimension, thus significantly increasing the complexity of possible devices.

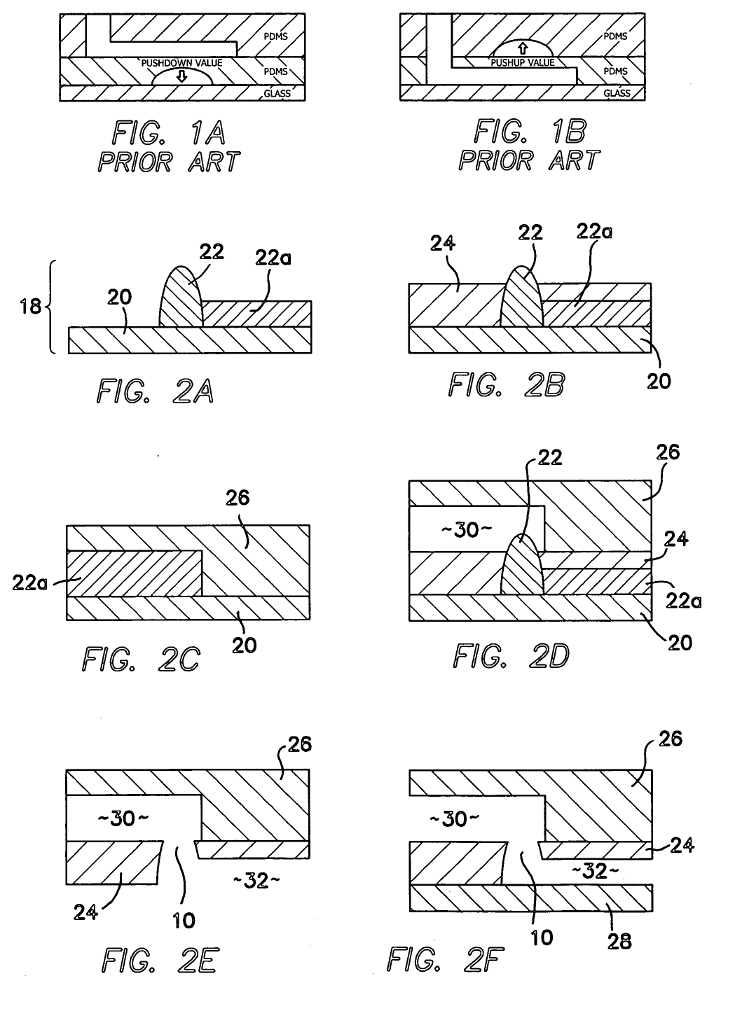

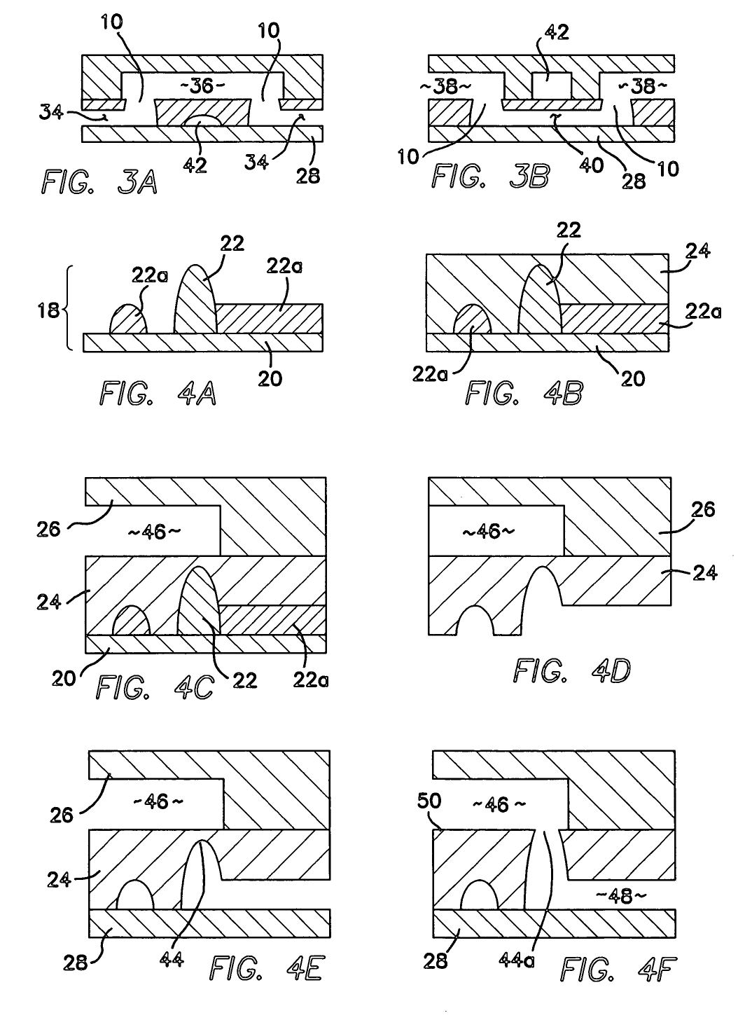

To construct a device with a via 10, we start with a hybrid mold 18 containing features 20, 22 of different heights as shown in enlarged side cross-sectional view in FIG. 2a. A standard hybrid mold 18 is constructed using Su8 photoresist 22a and Az50 photoresist 22 spun at 7 μm and 30 μpm heights respectively. The mold was baked at 200° C. for 1 hour to round the Az50 features 22. Their height was increased to 36 μm. In the resulting device, the via connects channels fabricated in different layers. Low features 22a in FIG. 4a are disposed on a thin layer mold 18 as follows. Su8-2005 photoresist 22a is spun over a test-grade silicon wafer 20 at 1000 rpm for 60 sec. The wafer 20 with photoresist 22a and is baked for 1 min at 65° C. and 3 min at 95°C. UV exposure through a black-and-white transparency mask is performed for 40 sec. Post-exposure baking is done for 1 min at 65° and 3 min at 95° C. The mold 18 is developed in 100% Su8 developer for 20 sec, rinsed in fresh developer and blown dry with nitrogen. Hard baking is done for 1 hr at 150° C., with a 15 min ramp up at the beginning and ramp down at the end.

High features 22 are disposed on a thin layer mold 18 as follows. The wafer 20 is exposed to HMDS vapor for 90 sec. Cold Az50 photoresist 22 is spun at 1400 rpm for 60 sec. The photoresist 22 is left to settle for 10 min. Soft baking is done for 2, 5, and 2 min at 65, 115, and 65° C., respectively. UV exposure through a black-and-white transparency mask is performed for 4 min. The mold is developed in a mixture of 3:1 water:2401 developer, rinsed in water, and blown dry with nitrogen. Hard baking is done for 1 hr at 200° C., wherein temperature is ramped up and down by turning the hot plate on and off. The mold 18 is left to cool down on the plate for 30-45 min. A thick layer mold 19 is in the same way as for high features 22. Chip fabrication PDMS chips were fabricated using the above molds and standard multi-layer techniques. The only varying parameter was the spin speed used for the thin PDMS layer 24.

As shown in FIG. 2b a 20:1 uncured PDMS layer 24 is spun at 4000 rpm (using Spincoater™ P6700), so that the high features 22 protrude through and over the PDMS surface 24. A PDMS layer 24 is partly cured, so that the thickness of layer 24 is positioned between the heights of the two photoresists 20 and 22. That condition is easily satisfied by conventional methods, e.g. using Az50 at 36 μm thickness, Su8 at 7 μm thickness and PDMS at 27 μm thickness. The choice of photoresists and thicknesses are illustrative only. Other materials and dimensions can be equivalently substituted without departing from the spirit and scope of the invention.

A thick 5:1 PDMS layer 26 is separately prepared over another mold 19 as shown in FIG. 2c, e.g. AZ at 36 μm thickness, partly cured at 80° C. for 30 min, peeled off, and the structures of FIGS. 2b and 2c are then assembled into the assembly of FIG. 2d. After the structures of FIGS. 2b and 2c are bonded together, the assembly is peeled off the first mold 18 to result in the structure as shown in FIG. 2e. The structure of FIG. 2e is then coupled, affixed or bonded to a glass or other substrate 28 as shown in FIG. 2f. Any means now known or later devised, such as epoxying, gluing, adhering, welding, curing, cementing, joining or the like, can be employed to fix or attach substrate 28 to the overlying partially completed structure, all of which shall be understood for the purposes of the claims and specification to be included within the term “bonding”. Thus, we have a via 10 connecting two channels 30 and 32 in different layers.

If two vias 10 are connected by a channel 36 or 40 that crosses over or under another channel 34 or 38 respectively, an overpass 12 or underpass 14 is produced respectively as shown in FIGS. 3a and 3b respectively. If the channels 34-40 of the lower and upper layers are filled with reagents, overpasses 12 and underpasses 14 would be used to allow crossing without mixing. It is to be understood that under certain conditions, overpasses 12 and underpasses 14 can also act as pushdown and pushup valves respectively by pressurizing cavities 42, but that can be selectively prevented by appropriate adjustment of dimensions, pressures, and polymer composition. Significantly, overpasses 12 and underpasses 14 allow the crossing of control channels with control channels and the crossing of flow channels with flow channels, thus expanding the maximal achievable complexity of both the control and flow layouts in a microfluidic circuit.

A septum 10a is a variant of a via 10. To construct a device with a septum 10a, we start with the same type of hybrid mold 18 as for a via 10 as shown in FIG. 4a. This time though, the height of the feature 22 must be reduced as compared FIG. 2b, for example to 22 μm. Then a PDMS layer 24 is spun as before, e.g. with 27 μm height as shown in FIG. 4b. This time, the taller feature 22 does not exceed the PDMS height of layer 24 but instead produces a thin membrane 44 of PDMS, e.g. 5 μm in this example. The rest of the fabrication steps are repeated as in FIGS. 2a-2f with via 10 as shown in FIGS. 4c-4f. Namely, a second thicker layer 26 is formed on a second mold (not shown) and is assembled on layer 24 as shown in FIG. 4c, mold 18 is removed as shown in FIG. 4d, and the remaining structure is mounted on a substrate 28 in FIG. 4e. The resulting device has a thin membrane 44 which does not allow flow from one of the channels 46 to the other channel 48, until the applied pressure exceeds a critical value preprogrammed by the fabrication parameters, such a thickness, area, and material strengths or characteristics of the corresponding layer in which membrane 44 is formed. Then the membrane 44 breaks and allows flow through a rupture-defined orifice 44a. Note that the septum breach or rupture pressure does not breach the nearby membrane 50 to the left of the septum 10a because it is significantly thicker than the septum 10a. Such a septum 10a for example allows water-tight packaging of microfluidic device subsystems until accessing them becomes necessary.

An important application of septums 10 is to keep hydrated the surface-derivatized compartments of devices during storage and shipping, e.g. in biological and/or biomedical applications such as immunoassays. A septum 10a can also be used as a microfuse 10b, the microfluidic equivalent of an electrical fuse, which protects the rest of the microfluidic circuitry from excessive pressure by diverting the flow to a safe exhaust port (not shown) when a critical value for the applied pressure is exceeded.

Systems of septums 10a can be fabricated in the same device and configured to breach at different pressures to allow passive valveless devices whose irreversible programming is completely controlled by applied pressure. Such devices can also be conceivably used as hydraulic computers and/or pressure sensors.

It is important to note that all these new device components utilize conventional fabrication techniques for soft lithography microfluidics and thus are completely compatible and integrable with existing microfluidic components that have been developed, e.g. valves, mixers, and pumps. Moreover, the new components benefit from the same advantages of parallel fabrication and integration-by-construction, thereby defeating the tyranny-of-numbers problem in the same way as the traditional devices do.

The new components for soft-lithography microfluidic devices of the illustrated embodiments enhance and expand the scope of applications, maximal complexity, and architectural flexibility of soft-lithography microfluidic devices. As such, they are a significant addition to the capabilities of microfluidic technology that is establishing itself as an important tool in biological and biomedical research and the related industries.

Thus, it can now be understood that the microfluidic vias 10 enable nested bioarrays by enabling three-dimensional connectivity in PDMS microfluidic chips and apply it to printing nested bioarrays. The fabrication of vias 10 presented above is as simple, fast, and easy as the one of standard multilayer devices, thereby removing the practical obstacles to the wide use of microfluidic architectures. In addition, vias 10 can work with significantly smaller dimensions, e.g. 7 μm tall channels connected by 25 μm wide vias. The ultimate limit in miniaturization is set by the submicron capabilities of optical lithography, rather than the softness of PDMS masters. The via fabrication steps are shown and described in connection with FIGS. 2a-2f.

In summary PDMS 26 is spun onto a standard hybrid mold 18 to a thickness smaller than the height of the taller features 22, but larger than the height of the shorter features 22a such as shown in FIG. 2a. As a result, the taller features 22 protrude through the upper PDMS surface 24. After curing, a separately fabricated layer 26 is assembled on top in such a way that the end of its channel 30 matches the protruding mold feature 22. After bonding, the device is peeled off and assembled to a substrate 28. Stacking the two PDMS layers in this fashion produces a vertical connection or via 10 between channels 30 and 32 fabricated in each layer. The functional result is a composite channel 30-32 that switches from one layer to another as it winds its way through the microfluidic chip.

The overpass 12 and underpass 14 of FIGS. 3a and 3b allow two channels traveling in the same layer to cross without mixing, as one of the channels switches over to an adjacent layer for the length of the crossing. Overpasses and underpasses can be arranged in series to enable three-dimensional flexibility in the architectural layout of a two-layer chip. Further enhancements are possible by increasing the number of stacked PDMS layers. The current practical limit is at least 7 layers due to the arrangement of simultaneous curing times, but it must be understood that the scope of the invention includes an indefinite number of layers. Multiple layers carrying channels interconnected with vias 10 open an enormous phase space of architectural possibilities to explore in future devices and applications. Again it is anticipated that the number of layers which can be exploited using the invention is not limited to seven, but is greater.

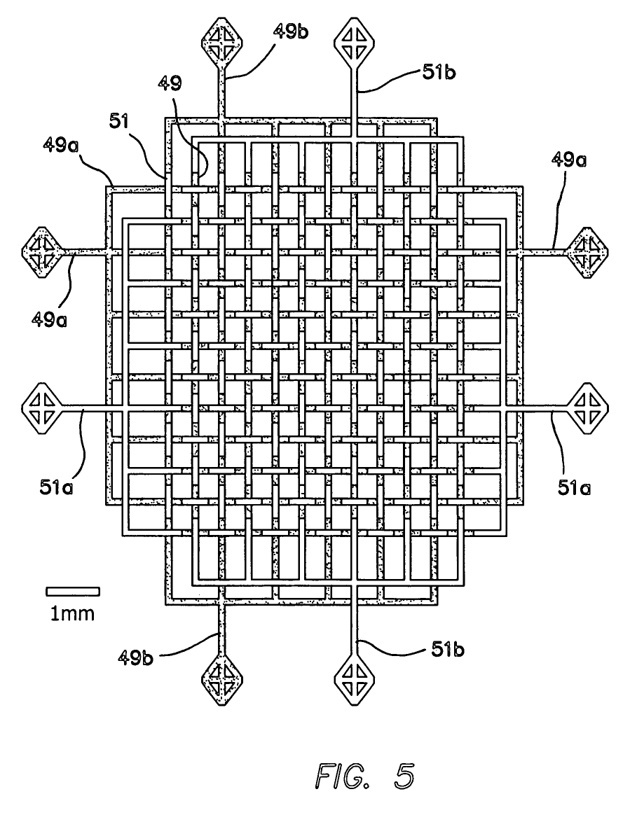

To determine the optimal via fabrication parameters, we created as an example a two-layer matrix shown diagrammatically in FIG. 5 containing 288 independent vias 10 of lateral dimensions that systematically vary between 25 and 80 μm in 5 μm steps. A number of chips with different thicknesses of the lower PDMS layer were produced using different spin speeds. Rounded via fabrication parameters as described below were optimized using a chip of the design illustrated in FIG. 5. Four sets of independent channels are laid out in the chip. 7×100 μm channels 49a and 49b in the lower layer and 36×100 μm channels 51a and 51b in the upper layer were connected by vias of 25-80 μm lateral dimensions, to produce four independent sets of three-dimensional channels. Optimal performance was achieved with 50-65 μm wide vias and 4000 rpm PDMS spin speed on 3 in wafers. At intersections of two channels at the same level in the chip, one channel was fabricated as an overpass or underpass depending on their level to allow crossing without mixing.

For some devices of larger dimensions and/or lower spin speeds, surface tension of the uncured PDMS formed a hump over the tall mold features. That hump cured into an unbroken membrane, producing a defective via 10. At smaller lateral dimensions, melting the photoresist during the rounding process lowered the height of the tall mold features 22. Thus they were too short to break through the subsequent PDMS layer 24. The incomplete formation of vias 10 at lower spin speeds and/or extreme dimensions resulted in a new device, namely a microfluidic septum 10a. The fabrication of FIGS. 4a-4e mimics that of the vias, except for spinning the PDMS 24 above all features 22 of the hybrid mold 18. Another way to think about a membrane 44 is as a purposefully defective via 10. The membrane 44 has the useful property that it would breach at a characteristic pressure determined by its fabrication parameters. For example, an 80×80 μm membrane at 3000 rpm on a 3 inch wafer over a 36 μm tall rounded channel breaches at 5 psi. Therefore, a membrane 44 can be used to isolate a certain section of the chip up to a specific applied pressure. In industrial chip packaging, such a membrane 44 could keep dust out, or reagents in, until the sealed section is to be accessed.

Also, if the sealed section is connected to an exhaust, then the membrane 44 acts as an irreversible microfluidic fuse 10b. When the applied pressure exceeds a certain hardwired value, the membrane 10a or microfluidic fuse 10b breaches, the fluid flows to the exhaust, and the pressure decreases. This scheme can be used to protect a sensitive section of the chip against excessive pressures. If a system of membranes 44 tuned to different breaching pressures is built within the same chip, then the chip could be configured to different final functionalities by applying respective pressures. This technique would allow mass-production of identical chips that could later be finalized to suit specific needs. Each such chip would then be operated at pressures too low to cause further architectural changes. Such chips could be arranged in a system to build fluidic analog computing circuitry impervious to electromagnetic pulses.

All vias 10 described above were made using rounded molds 18. Hence we next fabricated devices using non-rounded or square-profile molds 18a of the same architectural layout as used in FIG. 5. Non-rounded vias form successfully over a wider spectrum of dimensions than rounded vias. The smallest functional via 10 made to date is 25 μm square although this is not to be understood as a limitation of the size range of the invention. Virtually all vias 10 of 25-80 μm lateral dimensions were formed successfully at 2500 rpm on 3 inch wafers.

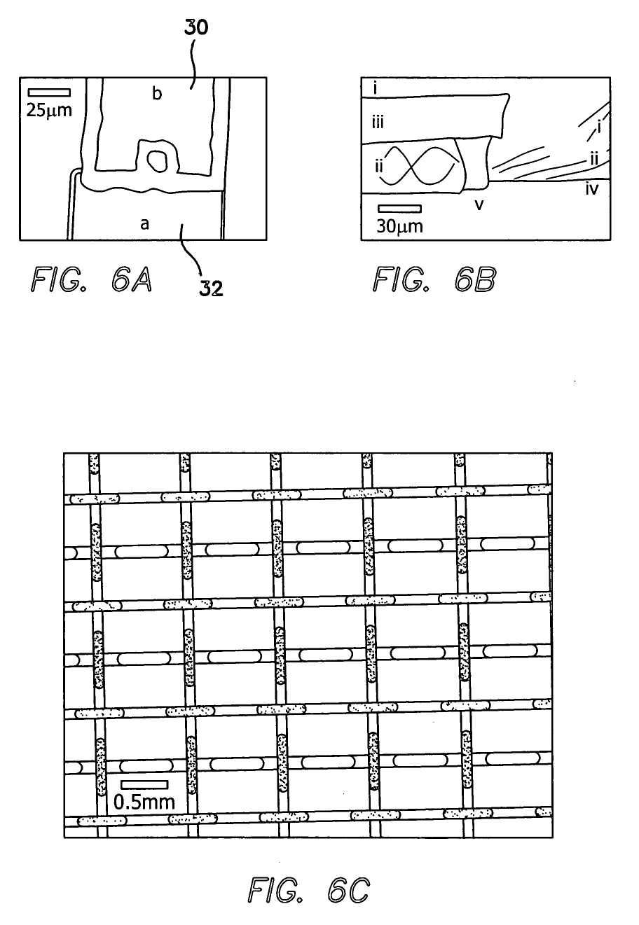

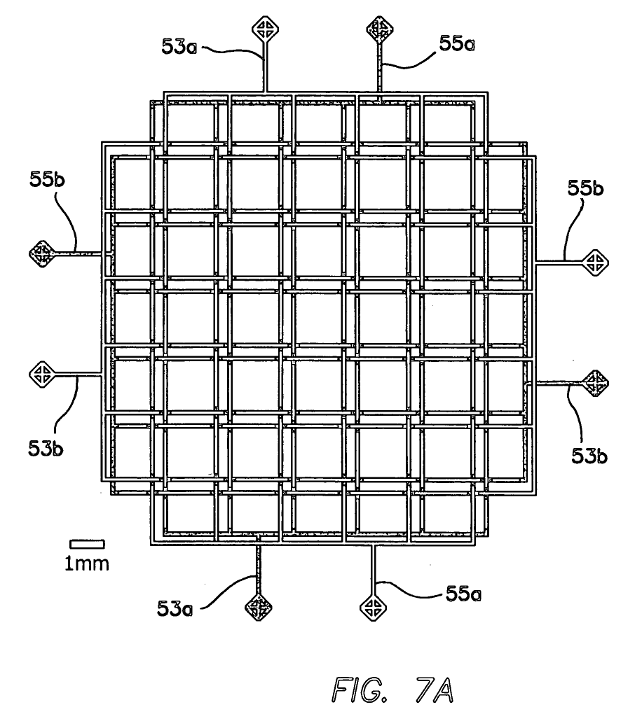

FIGS. 6a and 6b are photographs showing 25 μm-square functional vias. The lack of melting preserves the height of the narrow features, while the sharp edges help break the PDMS surface tension, thereby explaining the greater success of this technique. Non-rounded vias 10 can be formed successfully over a wider spectrum of dimensions than rounded vias 10. The smallest functional via 10 made to date is 25 μm square. FIG. 6a is a microphotograph of a top view of a via 10 showing lower channel 32 and upper channel 30. FIG. 6b is a microphotograph of a side cross-sectional view which shows upper layer 26, lower layer 24, upper channel 30, lower channel 32, and via 10. The chip was peeled off the slide, cut with a razor, and laid on its side to take the photo. FIG. 6c is a microphotograph of the 4-plex design of the type shown in FIG. 5 executed with non-rounded vias 10 at 2500 rpm PDMS spin speed. The four channel sets 49a, 49b, 51a, 51b were then filled with solutions containing plain buffer, fluorescein, Cy3, and Cy5 dyes; a colorless image and three false-color fluorescence images in blue, green, and red, respectively, were combined to produce the shown result in FIG. 6c. Of the 288 vias of varying sizes, there were only 2 defective ones suggesting that surface tension can produce membranes for sufficiently wide features of a non-rounded mold.

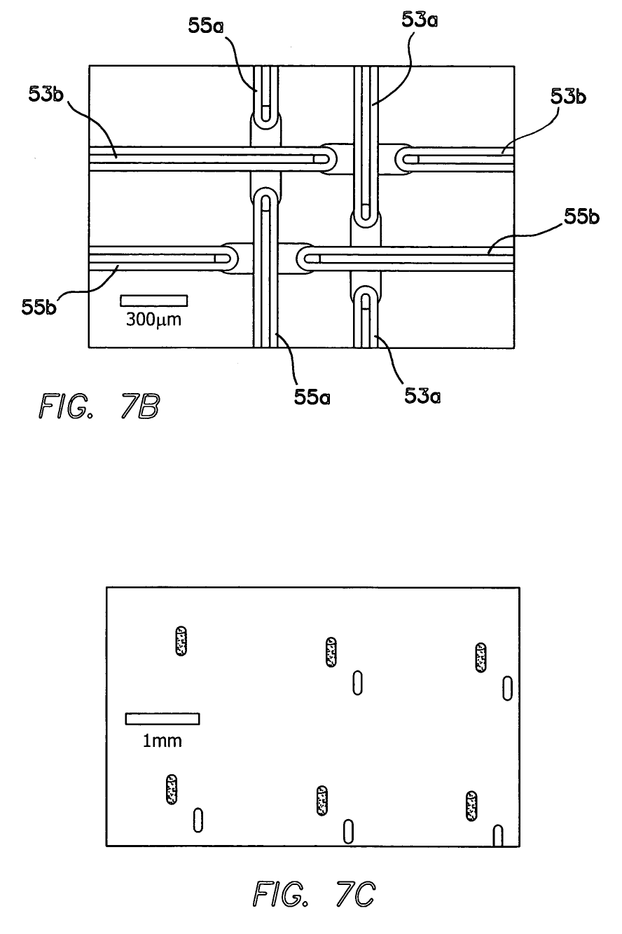

FIGS. 7a-7c illustrate application of the invention to the printing of nested bioarrays. One of the applications of vias 10 is printing bioarrays, e.g. protein or DNA arrays for immunoassays or hybridization expression analysis. As a particular example, we designed another chip as illustrated in the layout diagram of FIG. 7a containing independent sets of three-dimensional channels53a, 53b, 55a and 55b. Its primitive cell is a 4-plex cell as shown in FIG. 7b, wherein each set accesses the substrate 28 through an underpass in one respective location. CRP (c-reactive protein) and ferritin monoclonal antibodies were each fed in a separate channel set 53a, and 55a and bound to the respective epoxide locations. We washed away the unbound excess with buffer, peeled off the PDMS chip, and passivated the unreacted epoxide with Tris buffer. We pipetted a mixture of CRP and ferritin antigens and fluorescently tagged polyclonal antibodies onto the slide. Fluorescent labeling of CRP polyclonal antibodies and ferritin polyclonal antibodies were respectively labeled with DyLight 547 NHS-Ester and DyLight 647 NHS-Ester from Pierce. The samples were then purified using Zeba Desalt Spin Columns (exclusion limit MW 7,000) from Pierce. After incubation and washing, fluorescence detection led to the mixed false color image in FIG. 7c. The green (red) spots are produced by the Cy3 (Cy5) tags on the CRP (ferritin) polyclonal antibody respectively. The locations of the spots match the substrate access of the CRP (ferritin) monoclonal antibody respectively. The results indicate the correct completion of the corresponding sandwich immunoassays.

As FIG. 7c shows, the via technology of the invention provides a simple, fast, and inexpensive way to construct arrays of bioarrays (or “nested bioarrays”). To borrow an idea from semiconductor industry, a large substrate wafer could thus be derivatized with complete parallelism and subsequently diced to yield a large number of identical microchips, each ready to be used for multiple tests on a separate sample. This approach could lead to a class of standardized inexpensive nanomedicine chips that could prove revolutionary in today's world of skyrocketing healthcare costs and mounting pressures for true personalized preventive medicine.

The 4-plex layer of FIG. 7a is a special case wherein underpasses double up as deposition access channels. If the number of individual reagents is increased, adjacent channels cannot jump over each other to create the super-array, unless they also access the substrate in extraneous locations. To solve this problem, it is sufficient to increase the number of layers to three, wherein the first layer accesses the substrate, the second layer accommodates most of the length of the channels, and the third layer houses overpasses 12, so that the channels in the second layer can cross without mixing. This three-layer scheme can theoretically handle any number of individual reagents, and thus an arbitrary n-plex.

In conclusion, herein we have presented a fundamental technological advance that enables significant enhancements of the architectural complexity of three-dimensional PDMS microfluidic-devices by simple and easy means. The demonstrated applications are nested bioarrays, but by no means exhaust the applications in which the invention may be used to advantage.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, the invention may also be employed to fabricate novel autoregulatory devices in Newtonian fluids, which are disclosed in copending application Ser. No. ______, filed on ______, and based on U.S. Provisional Patent Application Ser. No. 60/764,245, filed on Feb. 1, 2006, which has been incorporated herein by reference.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method of forming a via, septum or microfuse in a multilayer microfluidic circuit comprising:
providing a first mold with at least one high feature and at least one low feature;
forming a first layer over the high feature and a low feature on the first mold, the high feature extending a predetermined height through the first layer to later define a via or extending near to the first layer to later define a membrane therein of a predetermined thickness, the low feature defining a later formed lower channel in the first layer in communication with the later formed via or membrane;
providing a second layer on the first layer, the second layer having at least one upper channel formed therein, so that the high feature extends into the upper channel in the second layer or is positioned adjacent to the upper channel in the second layer;
removing the first mold including the high feature and the low feature to define a partially completed structure; and
assembling the partially completed structure onto a substrate layer, whereby the via, septum or microfuse is formed between different, adjacent vertical levels in the multilevel microfluidic circuit.

2. The method of claim 1 where providing the second layer comprises providing a second mold with at least one feature to later define the upper channel, forming the second layer over the second mold, partially curing the second layer, and removing the second mold.

3. The method of claim 2 where forming the first layer comprises partially curing the first layer, assembling the first and second layers together in an aligned relationship so that the high feature extends into the upper channel in the second layer or is positioned adjacent to the upper channel in the second layer, and further curing of the first and second layers in an assembled configuration to bond the first and second layers together before removing the first mold.

4. The method of claim 1 where assembling the partially completed structure onto a substrate layer comprises bonding the partially completed structure to the substrate layer.

5. The method of claim 1 where providing the first mold comprises providing the first mold with two high features, where forming the first layer comprises forming the first layer over the two high features, and further comprising communicating the later defined vias or membranes with the upper or lower channel to form an overpass or underpass respectively.

6. The method of claim 1 where forming a first layer over the high feature extending near to the first layer to later define a membrane therein of a predetermined thickness further comprises selecting fabrication parameters of the membrane to allow rupture at a predetermined pressure.

7. The method of claim 6 where selecting fabrication parameters of the membrane comprises selecting thickness, area, or material characteristics of the membrane.

8. The method of claim 1 further comprising repeating the steps of providing the first mold, forming a first layer over the high feature extending near to the first layer to later define a membrane therein of a predetermined thickness, providing the second layer, removing the first mold and assembling the partially completed structure onto the substrate layer to simultaneously provide a plurality of septums or microfuses having a plurality of different rupture pressures.

9. The method of claim 1 further comprising repeating the steps of providing the first mold, forming a first layer over the high feature extending a predetermined height through the first layer to later define a via, providing the second layer, removing the first mold and assembling the partially completed structure onto the substrate layer to simultaneously provide a plurality of vias communicating a plurality of layers.

10. The method of claim 9 where repeating the steps to simultaneously provide a plurality of vias communicating a plurality of layers comprises simultaneously intercommunicating more than two layers.

11. The method of claim 9 where repeating the steps to provide a plurality of vias communicating a plurality of layers comprises simultaneously intercommunicating at up to and including seven layers.

12. The method of claim 9 further comprising fabricating nested bioarrays utilizing the vias.

13. The method of claim 8 further comprising fabricating selectively openable hydrated surface-derivatized compartments in a biomedical microfluidic circuit by utilizing the septums.

14. The method of claim 8 further comprising fabricating microfuses in a microfluidic circuit to protect a selected portion of the microfluidic circuit from excessive pressure by diverting flow to a safe exhaust port when a critical value of pressure is exceeded.

15. The method of claim 8 further comprising fabricating passive valveless microfluidic circuits with an irreversible programming completely controlled by pressure by utilizing the septums and predetermined rupture thereof.

16. The method of claim 15 where fabricating passive valveless microfluidic circuits comprises fabricating a hydraulic computer as well as simple hydraulic logic functions within these circuits.

17. The method of claim 15 where fabricating passive valveless microfluidic circuits comprises fabricating a pressure sensor.

18. The method of claim 1 further comprising rounding the vias during the fabrication thereof.

19. The method of claim 1 further comprising controlling temperature of fabrication to avoid rounding the vias during the fabrication thereof.

20. An apparatus fabricated by the method of claim 1.
